(19) United States
(12) Patent Application Publication
(10) Pub. No.: US 2016/0368254 A1
(43) Pub. Date: Dec. 22, 2016

(54) METHOD FOR BONDING DISPLAY PANEL TO AUXILIARY PANEL, AND DISPLAY DEVICE

(71) Applicants: BOE TECHNOLOGY GROUP CO., LTD, Beijing (CN); HEFEI XINSHENG OPTOELECTRONICS TECHNOLOGY CO., LTD, Hefei, Anhui (CN)

(72) Inventors: Wenjin FAN, Beijing (CN); Hongqiang LUO, Beijing (CN)

(73) Assignees: BOE TECHNOLOGY GROUP CO., LTD., Beijing (CN); HEFEI XINSHENG OPTOELECTRONICS TECHNOLOGY CO.,, Hefei, Anhui (CN)

(21) Appl. No.: 14/771,366

(22) PCT Filed: Mar. 17, 2015
(86) PCT No.: PCT/CN2015/074354

§ 371 Date: Aug. 28, 2015

(30) Foreign Application Priority Data
Oct. 11, 2014 (CN) 201410535110.8

(51) Int. Cl. B32B 37/12; B32B 7/12; B32B 37/14

(52) U.S. Cl. CPC B32B 37/12; B32B 37/14; B32B 7/12; B32B 2037/1253; B32B 2457/20; B32B 2307/412; B32B 2405/00; G06F 3/041

(57) ABSTRACT

The present disclosure provides a method for bonding a display panel to an auxiliary panel. The method includes steps of: providing an adhesive tape at a periphery of a surface, of one of the auxiliary panel and the display panel; providing a colorless, transparent liquid adhesive at a region surrounded by the adhesive tape, or at a region at a the other one of the auxiliary panel and the display panel corresponding to the region surrounded by the adhesive tape; bonding the display panel to the auxiliary panel; and curing the colorless, transparent liquid adhesive so as to adhere the display panel to the auxiliary panel through the adhesive tape and the cured colorless, transparent liquid adhesive.

### TECHNICAL FIELD

The present disclosure relates to the field of display devices, in particular to a method for bonding a display panel to an auxiliary panel, and a display device manufactured by the method.

### BACKGROUND

After the manufacture of a display panel, it is required to arrange an auxiliary panel onto the display panel so as to form a complete display device. Usually, the auxiliary panel is arranged onto the display panel by bonding.

In the related art, generally the auxiliary panel may be bonded onto the display panel in two ways. One of them includes adhering the auxiliary panel to the display panel by a transparent solid adhesive (i.e., a transparent adhesive tape). However, when this way is adopted, bubbles may easily occur between the display panel and the auxiliary panel. The other one of them includes adhering the auxiliary panel to the display panel by a transparent liquid adhesive. However, when this way is adopted, it is difficult to control a dispersion range of the transparent liquid adhesive, and such defects as regions having too little adhesive, regions having too much adhesive and Mura will easily occur at a periphery of the display device.

Hence, there is an urgent need to find a way to prevent the occurrence of the above defects when the display panel is bonded to the auxiliary panel.

### SUMMARY

An object of the present disclosure is to provide a method for bonding a display panel to an auxiliary panel and a display device manufactured by the method, so as to improve the yield of the display device.

In one aspect, the present disclosure provides in one embodiment a method for bonding a display panel to an auxiliary panel, including steps of providing an adhesive tape at a periphery of a surface of one of the auxiliary panel and the display panel; providing a colorless, transparent liquid adhesive at a region surrounded by the adhesive tape, or at a region at the other one of the auxiliary panel and the display panel corresponding to the region surrounded by the adhesive tape; bonding the display panel to the auxiliary panel; and curing the colorless, transparent liquid adhesive so as to adhere the display panel to the auxiliary panel through the adhesive tape and the cured colorless, transparent liquid adhesive.

Alternatively, the colorless, transparent liquid adhesive at the region surrounded by the adhesive tape, or at the region at the other one of the auxiliary panel and the display panel corresponding to the region surrounded by the adhesive tape, is provided at an amount so as to till up a cavity formed after the display panel is bonded to the auxiliary panel without filling any colorless, transparent liquid adhesive.

Alternatively, the colorless, transparent liquid adhesive is an ultraviolet (UV)-curable adhesive, and the step of curing the colorless, transparent liquid adhesive includes irradiating the colorless, transparent liquid adhesive with UV light, so as to cure the colorless, transparent liquid adhesive.

Alternatively, the auxiliary panel includes a transparent cover plate or a touch panel.

Alternatively, the auxiliary panel includes a touch panel which includes a panel body and a black matrix arranged at a periphery of a surface of the panel body, and the adhesive tape is arranged on the black matrix.

Alternatively, the adhesive tape is of a width not greater than the black matrix.

Alternatively, when providing the adhesive tape, an inner edge of the adhesive tape does not extend beyond an inner edge of the black matrix, and an outer edge of the adhesive tape does not extend beyond an outer edge of the black matrix.

Alternatively, the width of the adhesive tape is within a range from 1 mm to 3 mm.

Alternatively, an actual amount of the colorless, transparent liquid adhesive is calculated using the following equation, so that a gap between the auxiliary panel and the display panel is within a range from 100 μm to 300 μm after the colorless, transparent liquid adhesive has been cured: M=α*(H+h)*s*ρ, wherein M represents the actual amount of the colorless, transparent liquid adhesive, α represents a correction coefficient and has a value greater than 0, H represents a thickness of the adhesive tape, h represents a thickness of the black matrix, s represents an area of the region surrounded by the adhesive tape, and ρ represents a density of the colorless, transparent liquid adhesive.

Alternatively, 95%≦α≦105%.

Alternatively, the adhesive tape is a colorless, transparent adhesive tape.

Alternatively, a profile of the outer edge of the adhesive tape conforms to a profile of an outer edge of one of the display panel and the auxiliary panel where the adhesive tape is provided.

In another aspect, the present disclosure provides in one embodiment a display device including a display panel and an auxiliary panel which are fixedly connected to each other through an adhesive. The adhesive includes an adhesive tape provided at a periphery of a surface of one of the auxiliary panel and the display panel, and a colorless, transparent solid adhesive provided at a region surrounded by the adhesive tape, or at a region at the other one of the auxiliary panel and the display panel corresponding to the region surrounded by the adhesive tape. The colorless, transparent solid adhesive is obtained by curing a colorless, transparent liquid adhesive.

Alternatively, the colorless, transparent liquid adhesive is a UV-curable adhesive.

Alternatively, the auxiliary panel includes a transparent cover plate or a touch panel.

Alternatively, the auxiliary panel includes a touch panel which includes a panel body and a black matrix arranged at a periphery of a surface of the panel body, and the adhesive tape is arranged on the black matrix.

Alternatively, the adhesive tape is of a width not greater than the black matrix.

Alternatively, when providing the adhesive tape, an inner edge of the adhesive tape does not extend beyond an inner edge of the black matrix, and an outer edge of the adhesive tape does not extend beyond an outer edge of the black matrix.

Alternatively, the width of the adhesive tape is within a range from 1 mm to 3 mm.

Alternatively, a gap between the auxiliary panel and the display panel is within a range from 100 μm to 300 μm.

Alternatively, the adhesive tape is a colorless, transparent adhesive tape.

Alternatively, a profile of the outer edge of the adhesive tape conforms to a profile of an outer edge of one of the display panel and the auxiliary panel where the adhesive tape is provided

According to the method in the embodiments of the present disclosure, after the colorless, transparent liquid adhesive has been cured, a middle region of the display panel is adhered to a middle region of the auxiliary panel. Hence, no bubbles will occur between the middle region of the display panel and the middle region of the auxiliary panel, and the flow of the colorless, transparent liquid adhesive will be restrained by the adhesive tape during the bonding of the display panel to the auxiliary panel. As a result, it is able prevent the occurrence of such defects as regions having too much adhesive, regions having too little adhesive and Mura at a periphery of the display device.

### BRIEF DESCRIPTION OF THE DRAWINGS

The following drawings are provided for further understanding of the present disclosure, and as a part of the description, they are provided together with the following embodiments merely for illustrative purposes, but shall not be regarded as limitations to the present disclosure. In these drawings,

FIG. 1 is a flow chart of a method for bonding a display panel to an auxiliary panel according to one embodiment of the present disclosure;

FIG. 2 is another flow chart of the method for bonding the display panel to the auxiliary panel according to one embodiment of the present disclosure;

FIG. 3 is a front view of the auxiliary panel according to one embodiment of the present disclosure;

FIG. 4 is a top view of the auxiliary panel in FIG. 3:

FIG. 5 is a front view of the auxiliary panel in FIG. 3 after an adhesive tape is arranged on a black matrix;

FIG. 6 is a top view of the auxiliary panel in FIG. 5;

FIG. 7 is a front view of the auxiliary panel in FIG. 5 after a colorless, transparent liquid adhesive is provided at a region surrounded by the adhesive tape;

FIG. 8 is a top view of the auxiliary panel in FIG. 7; and

FIG. 9 is a front view of a display device according to one embodiment of the present disclosure.

### REFERENCE SIGN LIST

100 auxiliary panel

110 panel body

120 black matrix

210 adhesive tape

220 colorless, transparent liquid adhesive 220′ cured colorless, transparent liquid adhesive

300 display panel

### DETAILED DESCRIPTION

The present disclosure will be described hereinafter in conjunction with the drawings and embodiments. It should be appreciated that, the following embodiments are for illustrative purposes only, and shall not be used to limit the present disclosure.

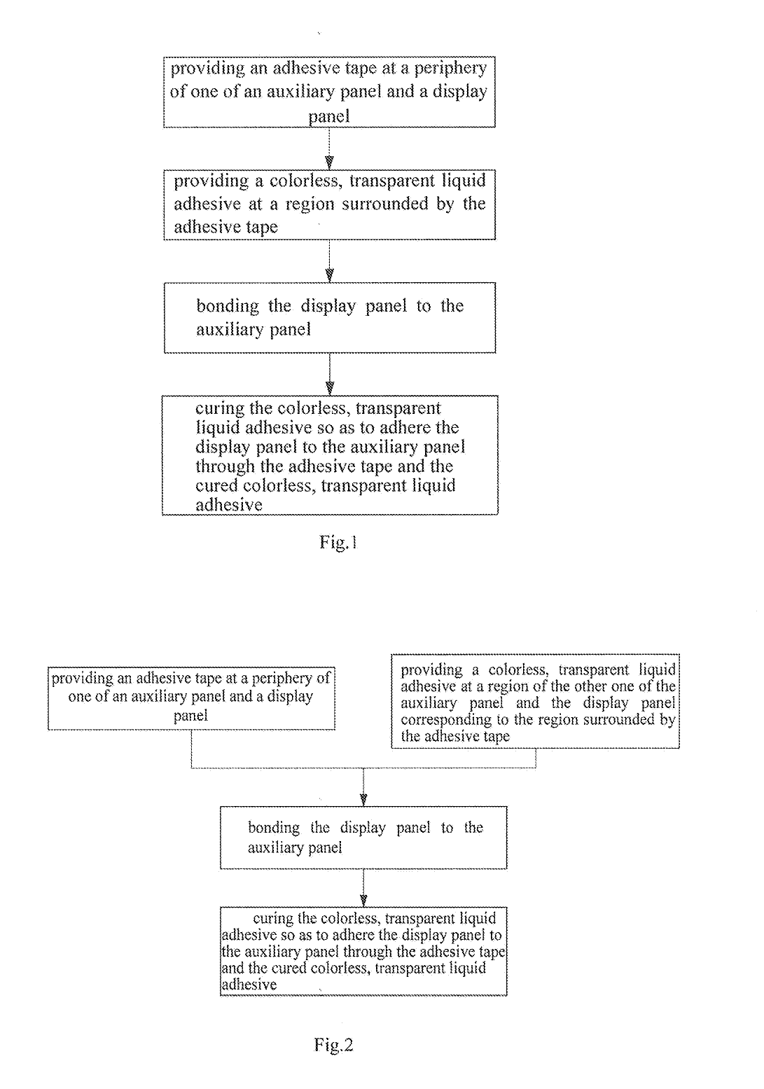

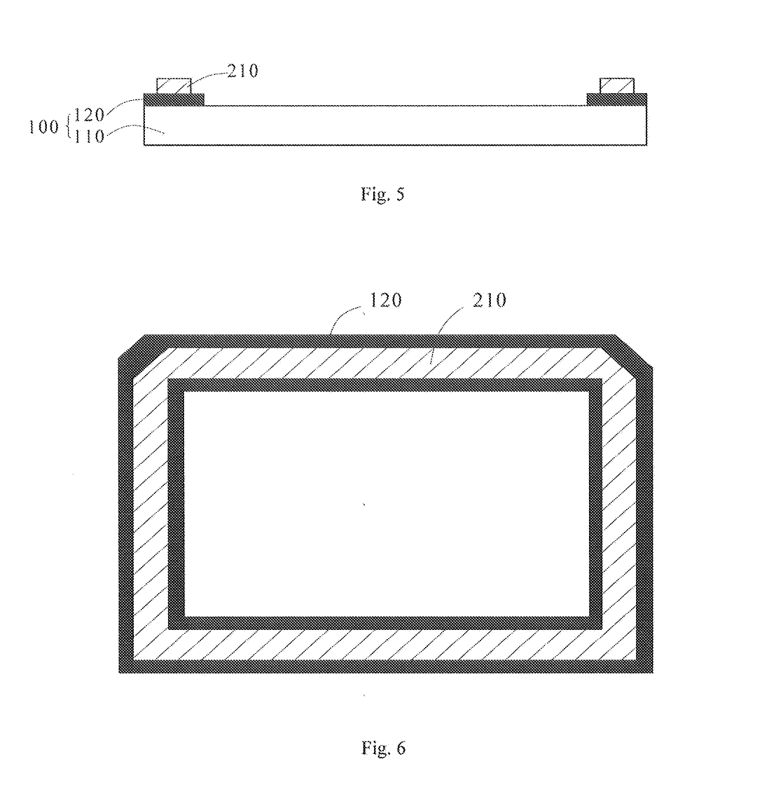

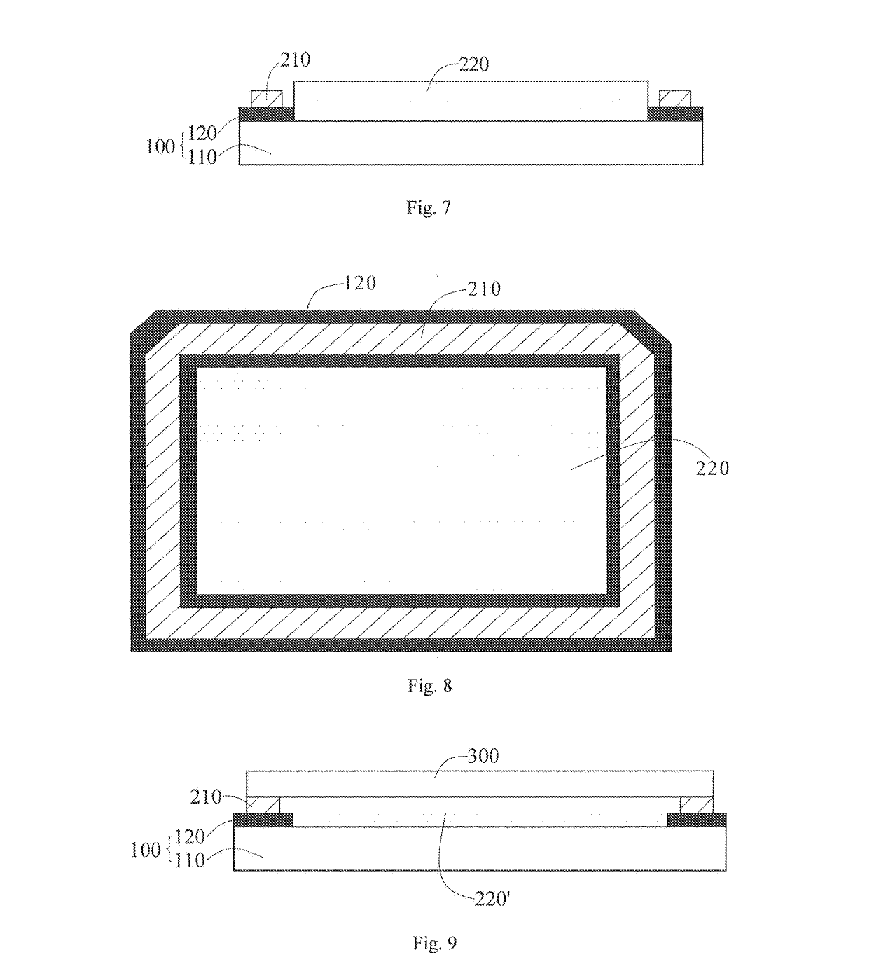

The present disclosure provides in one embodiment a method for bonding a display panel 300 to an auxiliary panel 100, which, as shown in FIGS. 1-9, includes steps of: providing an adhesive tape 210 at a periphery of one of the auxiliary panel 100 and the display panel 300 (preferably at a periphery of a surface of one of the auxiliary panel 100 and the display panel 300, and FIGS. 5-6 show the situation where the adhesive tape 210 is provided at the periphery of the surface of the auxiliary panel 100); providing a colorless, transparent liquid adhesive 220 at a region surrounded by the adhesive tape 210 (as shown in FIGS. 1, 7 and 8), or at a region at a the other one of the auxiliary panel and the display panel corresponding to the region surrounded by the adhesive tape (as shown in FIG. 2) (in some special application scenarios, a colored, transparent liquid adhesive may also be adopted); bonding the display panel 300 to the auxiliary panel 100; and curing the colorless, transparent liquid adhesive so as to adhere the display panel 300 to the auxiliary panel 100 through the adhesive tape 210 and the cured colorless, transparent liquid adhesive 220′.

According to the method in the embodiments of the present disclosure, after the colorless, transparent liquid adhesive has been cured, a middle region of the display panel is adhered to a middle region of the auxiliary panel. Hence, no bubbles will occur between the middle region of the display panel and the middle region of the auxiliary panel, and the flow of the colorless, transparent liquid adhesive will be restrained by the adhesive tape during the bonding of the display panel 300 to the auxiliary panel 100. As a result, it is able prevent the occurrence of such defects as regions having too much adhesive, regions having too little adhesive and Matra at a periphery of the display device.

It can be seen that, through the method in the embodiments of the present disclosure, it is able to prevent the occurrence of the bubbles between the display panel 300 and the auxiliary panel 100, and the occurrence of such defects as regions having too much adhesive, regions having too little adhesive and Mura at a periphery of the display device after the colorless, transparent liquid adhesive has been cured. In other words, when the display panel 300 is bonded to the auxiliary panel 100 through the method in the embodiments of the present disclosure, it is able to improve the product yield.

In the embodiments of the present disclosure, the adhesive tape may be provided at the periphery of the auxiliary panel 100 or the display panel 300.

In the embodiments of the present disclosure, a color of the adhesive tape 210 is not particularly defined. The adhesive tape 210 may be a colorless, transparent adhesive tape, or a colored, transparent adhesive tape, or a nontransparent adhesive tape, e.g., a black adhesive tape. When the black matrix is arranged at the periphery of the surface of the auxiliary panel 100 and/or the display panel 300, the adhesive tape 210 may be the colorless, transparent adhesive tape or the black adhesive tape. When the display device formed by bonding the auxiliary panel 100 to the display panel 300 is free of bezel or has a narrow bezel, the adhesive tape 210 may be the colorless, transparent adhesive tape.

There are two implementation modes for the above-mentioned method. One of them includes providing the colorless, transparent liquid adhesive 220 at the region surrounded by the adhesive tape 210 as shown in FIGS. 1, 7 and 8. Through this mode, it is able to improve the bonding accuracy.

The other of them includes providing the adhesive tape on one of the display panel and the auxiliary panel, and providing the colorless, transparent liquid adhesive on the other of the display panel and the auxiliary panel, as shown in FIG. 2. In addition, after the display panel is bonded to the auxiliary panel, the region where the colorless, transparent liquid adhesive is provided corresponds to the region surrounded by the adhesive region. Through this mode, it is able to improve the production efficiency.

The above two implementation modes may be selected in accordance with the requirements on the product and the production practice.

In order to further prevent the occurrence of the bubbles between the display panel 300 and the auxiliary panel 100, alternatively, the display panel 300 is bonded to the auxiliary panel by a vacuum laminator.

In the embodiments of the present disclosure, ingredients of the colorless, transparent liquid adhesive are not particularly defined herein, as long as the auxiliary panel 100 is adhered to the display panel 300 through the colorless, transparent liquid adhesive. For example, the colorless, transparent liquid adhesive may be a photocurable adhesive, and alternatively, a UV-curable adhesive. Hence, the step of curing the colorless, transparent liquid adhesive (the UV-curable adhesive) includes irradiating the colorless, transparent liquid adhesive with UV light, so as to cure the colorless, transparent liquid adhesive.

In the embodiments of the present disclosure, the colorless, transparent liquid adhesive at the region surrounded by the adhesive tape 210, or at the region at the other one of the auxiliary panel and the display panel corresponding to the region surrounded by the adhesive tape 210, may be provided at an amount so as to fill up a cavity formed after the display panel is bonded to the auxiliary panel without filling any colorless, transparent liquid adhesive. As a result, after the colorless, transparent liquid adhesive has been cured, it is able to prevent the occurrence of such defects as regions having too much adhesive, regions having too little adhesive and Mura at a periphery of the display device in a better manner.

In the embodiments of the present disclosure, the auxiliary panel 100 may include a transparent cover plate or a touch panel. Alternatively, the auxiliary panel 100 is colorless and transparent.

As shown in FIGS. 3 and 5, the auxiliary panel 100 includes a touch panel which includes a panel body 110 and a black matrix 120 arranged at a periphery of a surface of the panel body 110, and the adhesive tape 210 is arranged on the black matrix 120. It should be appreciated that, the black matrix 120 functions as to cover metal wires in the touch panel. Alternatively, the panel body is also colorless and transparent.

To be specific, a theoretical amount in of the colorless, transparent liquid adhesive 220 may be calculated using the following equation:

m=(H+h)*s*ρ,

wherein In represents the theoretical amount of the colorless, transparent liquid adhesive 220, H represents a thickness of the adhesive tape 210, h represents a thickness of the black matrix 120, s represents an area of the region surrounded by the adhesive tape 210, and ρ represents a density of the colorless, transparent liquid adhesive 220.

During the implementation, an actual amount M of the colorless, transparent liquid adhesive 220 may be calculated using the following equation, so that a gap between the auxiliary panel and the display panel is within a range from 100 μm to 300 mm after the colorless, transparent liquid adhesive has been cured: M=α*m=α*(H+h)*s*ρ, wherein M represents the actual amount of the colorless, transparent liquid adhesive 220, α represents a correction coefficient and has a value greater than 0, m represents the theoretical amount of the colorless, transparent liquid adhesive 220, H represents the thickness of the adhesive tape 210, h represents the thickness of the black matrix 120, s represents the area of the region surrounded by the adhesive tape 210, and ρ represents the density of the colorless, transparent liquid adhesive 220,

After the colorless, transparent liquid adhesive 220 has been cured, the gap between the auxiliary panel 100 and the display panel 300 is within the range from 100 μm to 300 μm, so as to ensure flatness of the display device formed after the auxiliary panel 100 is bonded to the display panel 300, and to provide the whole display device with a small thickness. 100561 In the embodiments of the present disclosure, when the thickness H of the adhesive tape 210, the thickness h of the black matrix 120 and the area s of the region surrounded by the adhesive tape 210 have been determined, a value of a may be selected so as to enable the gap between the auxiliary panel and the display panel to be within the range from 100 μm to 300 μm.

Alternatively, a may be of a value from 95% to 105%.

Usually, the adhesive tape 210 may be of a width not greater than the black matrix 120. In addition, when providing the adhesive tape 210, an inner edge of the adhesive tape 210 may not extend beyond an inner edge of the black matrix 120, and an outer edge of the adhesive tape 210 may not extend beyond an outer edge of the black matrix 120. In an alternative embodiment, the width of the adhesive tape 210 may be within a range from 1 mm to 3 mm.

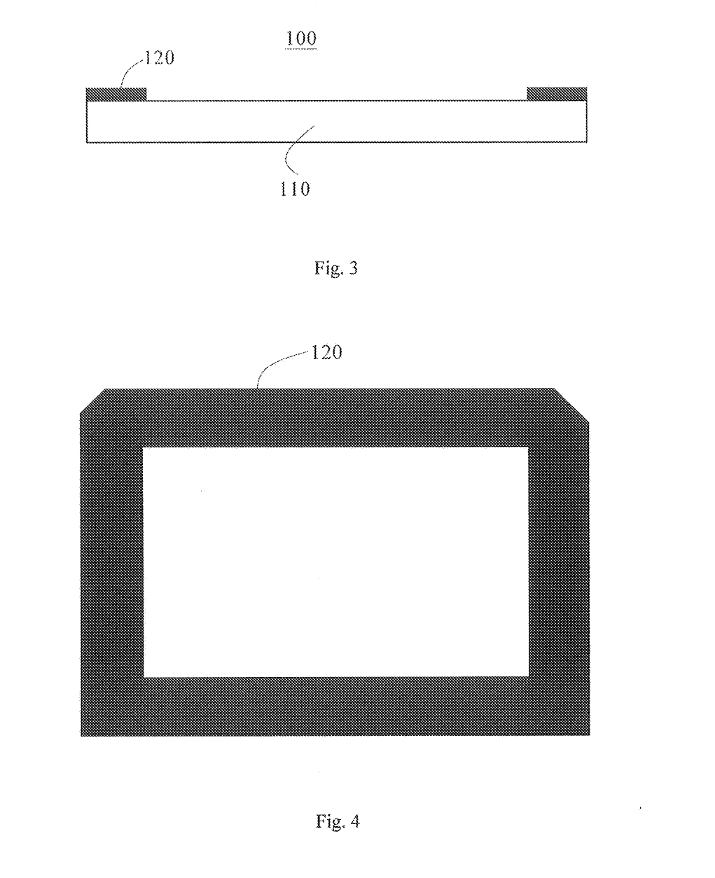

In normal case, a size and a shape of the surface of the display panel 300 may conform to a size and a shape of the surface of the auxiliary panel 100. However, in some cases, the size and shape of the surface of the display 300 may not conform to those of the surface of the auxiliary panel 100. When they conform to each other, usually the display panel 300 and auxiliary panel 100 are each of a rectangular shape. In some special application scenarios, the shapes of the display panel 300 and the auxiliary panel 100 may each be of an irregularly rectangular shape, or any other regular or irregular shape. For example, in FIGS. 3 and 4, the auxiliary panel 100 is of a rectangular shape with two chamfered corners. To be specific, the two chambered corners are located at positions where any long side of the rectangle meets two short sides thereof, respectively.

Because the adhesive tape 210 is solid, it is easy to acquire the adhesive tapes 210 with various shapes. In order to ensure firm adhesion between the display panel 300 and the auxiliary panel 100, alternatively, a profile of the outer edge of the adhesive tape 210 may conform to a profile of an outer edge of one of the display panel 300 and the auxiliary panel 100 where the adhesive tape 210 is provided. Prior to providing the adhesive tape 210 on the display panel 300 or the auxiliary panel 100, the adhesive tape may be pre-treated (e.g., tailored), so as to obtain the adhesive tape with the mentioned profile of the outer edge.

The present disclosure further provides in one embodiment a display device manufactured by the above-mentioned method. As shown in FIG. 9, the display device includes the display panel 300 and the auxiliary panel 100 which are fixedly connected to each other through an adhesive. The adhesive includes the adhesive tape 210 provided at a periphery of a surface of one of the auxiliary panel 100 and the display panel 300, and the colorless, transparent solid adhesive 220 provided at a region surrounded by the adhesive tape 210, or at a region at the other one of the auxiliary panel 100 and the display panel 300 corresponding to the region surrounded by the adhesive tape 210. The colorless, transparent solid adhesive 220′ is obtained by curing the colorless, transparent liquid adhesive 220. Alternatively, the adhesive tape 210 is provided at the periphery of the surface of one of the auxiliary panel 100 and the display panel 300.

As mentioned hereinbefore, when the display panel 300 is bonded to the auxiliary panel 100, the middle region of the display panel 300 is adhered to the middle region of the auxiliary panel 100 by curing the colorless, transparent liquid adhesive. Hence, no bubbles will occur between the middle region of the display panel and the middle region of the auxiliary panel, and the flow of the colorless, transparent liquid adhesive will be restrained by the adhesive tape 210. As a result, it is able prevent the occurrence of such defects as regions having too much adhesive, regions having too little adhesive and Mura at a periphery of the display device. In addition, it is able to adhere peripheral regions of the display panel 300 and the auxiliary panel 100 together through the adhesive tape 210 itself.

Hence, for the display device in the embodiments of the present disclosure, it is able to provide a well appearance (i.e., to prevent the occurrence of the bubbles), and to improve the adhesion strength between the display panel 300 and the auxiliary panel 100.

As mentioned above, in the embodiments of the present disclosure, the auxiliary panel 100 may include a transparent cover plate or a touch panel. Alternatively, the auxiliary panel 100 is colorless and transparent.

When the auxiliary panel 100 includes the touch panel, the touch panel may include the panel body 110 and the black matrix 120 arranged at a periphery of a surface of the panel body 110, and the adhesive tape 210 is arranged on the black matrix 120. The adhesive tape 210 may be of a width not greater than the black matrix 120. An inner edge of the adhesive tape 210 may not extend beyond an inner edge of the black matrix 120, and an outer edge of the adhesive tape 210 may not extend beyond an outer edge of the black matrix 120. Alternatively, the panel body 110 may also be colorless and transparent.

As mentioned above, a color of the adhesive tape 210 is not particularly defined herein. The adhesive tape 210 may be a colorless, transparent adhesive tape, or a colored, transparent adhesive tape, or a nontransparent adhesive tape, egg., a black adhesive tape. When the black matrix is arranged at the periphery of the surface of the auxiliary panel 100 and/or the display panel 300, the adhesive tape 210 may be the colorless, transparent adhesive tape or the black adhesive tape. When the display device formed by bonding the auxiliary panel 100 to the display panel 300 is free of bezel or has a narrow bezel, the adhesive tape 210 may be the colorless, transparent adhesive tape.

In an alternative embodiment, the width of the adhesive tape 210 may be within a range from 1 mm to 3 mm.

In order to provide the display device with well flatness and a small thickness, alternatively, a gap between the auxiliary panel 100 and the display panel 300 may be within a range from 100 μm to 300 μm.

In order to improve the adhesion strength between the display panel 300 and the auxiliary panel 100, alternatively, a profile of the outer edge of the adhesive tape 210 may conform to a profile of an outer edge of one of the display panel 300 and the auxiliary panel 100 where the adhesive tape 210 is provided.

The above are merely the preferred embodiments of the present disclosure. It should be appreciated that, a person skilled in the art may make further modifications and improvements without departing from the spirit of the present disclosure, and these modifications and improvements shall also fall within the scope of the present disclosure.

1. A method for bonding a display panel to an auxiliary panel, comprising steps of:
providing an adhesive tape at a periphery of a surface of one of the auxiliary panel and the display panel;
providing a colorless, transparent liquid adhesive at a region surrounded by the adhesive tape, or at a region at the other one of the auxiliary panel and the display panel corresponding to the region surrounded by the adhesive tape;
bonding the display panel to the auxiliary panel; and
curing the colorless, transparent liquid adhesive so as to adhere the display panel to the auxiliary panel through the adhesive tape and the cured colorless, transparent liquid adhesive.

2. The method according to claim 1, wherein the colorless, transparent liquid adhesive at the region surrounded by the adhesive tape, or at the region at the other one of the auxiliary panel and the display panel corresponding to the region surrounded by the adhesive tape, is provided at an amount so as to fill up a cavity formed after the display panel is bonded to the auxiliary panel without filling any colorless, transparent liquid adhesive.

3. The method according to claim 1, wherein the colorless, transparent liquid adhesive is an ultraviolet (UV)-curable adhesive, and the step of curing the colorless, transparent liquid adhesive comprises irradiating the colorless, transparent liquid adhesive with UV light, so as to cure the colorless, transparent liquid adhesive.

4. The method according to claim 1, wherein the auxiliary panel comprises a transparent cover plate or a touch panel.

5. The method according to claim 4, wherein the auxiliary panel comprises the touch panel which includes a panel body and a black matrix arranged at a periphery of a surface of the panel body, and the adhesive tape is arranged on the black matrix.

6. The method according to claim 5, wherein the adhesive tape is of a width not greater than the black matrix.

7. The method according to claim 6, wherein when providing the adhesive tape, an inner edge of the adhesive tape does not extend beyond an inner edge of the black matrix, and an outer edge of the adhesive tape does not extend beyond an outer edge of the black matrix.

8. The method according to claim 6, wherein the width of the adhesive tape is within a range from 1 mm to 3 mm.

9. The method according to claim 5, wherein an actual amount of the colorless, transparent liquid adhesive is calculated using the following equation, so that a gap between the auxiliary panel and the display panel is within a range from 100 μm to 300 μm alter the colorless, transparent liquid adhesive has been cured: M=α*(H+h)*s*ρ, wherein M represents the actual amount of the colorless, transparent liquid adhesive, α represents a correction coefficient and has a value greater than 0, H represents a thickness of the adhesive tape, h represents a thickness of the black matrix, s represents an area of the region surrounded by the adhesive tape, and ρ represents a density of the colorless, transparent liquid adhesive.

10. The method according to claim 9, wherein 95%≦α≦105%.

11. The method according to claim 1, wherein the adhesive tape is a colorless, transparent adhesive tape.

12. The method according to claim 1, wherein a profile of the outer edge of the adhesive tape conforms to a profile of an outer edge of one of the display panel and the auxiliary panel where the adhesive tape is provided.

13. A display device, comprising a display panel and an auxiliary panel which are fixedly connected to each other through an adhesive, wherein the adhesive comprises an adhesive tape provided at a periphery of a surface of one of the auxiliary panel and the display panel, and a colorless, transparent solid adhesive provided at a region surrounded by the adhesive tape, or at a region at the other one of the auxiliary panel and the display panel corresponding to the region surrounded by the adhesive tape, and the colorless, transparent solid adhesive is obtained by curing a colorless, transparent liquid adhesive.

14. The display device according to claim 13, wherein the auxiliary panel comprises a transparent cover plate or a touch panel.

15. The display device according to claim 14, wherein the auxiliary panel comprises the touch panel which comprises a panel body and a black matrix arranged at a periphery of a surface of the panel body, and the adhesive tape is arranged on the black matrix.

16. The display device according to claim 15, wherein the adhesive tape is of a width not greater than the black matrix.

17. The display device according to claim 16, wherein the width of the adhesive tape is within a range from 1 mm to 3 mm.

18. The display device according to claim 13, wherein a gap between the auxiliary panel and the display panel is within a range from 100 μm to 300 μm.

19. The display device according to claim 13, wherein the adhesive tape is a colorless, transparent adhesive tape.

20. The display device according to claim 13, wherein a profile of the outer edge of the adhesive tape conforms to a profile of an outer edge of one of the display panel and the auxiliary panel where the adhesive tape is provided.
